(19) United States
(12) Patent Application Publication
(10) Pub. No.: US 2014/0239629 A1
(43) Pub. Date: Aug. 28, 2014

(54) GARDEN HOSE KINK MENDER APPARATUS

(71) Applicant: Michael Gill, Grand Rapids, MI (US)

(72) Inventor: Michael Gill, Grand Rapids, MI (US)

(21) Appl. No.: 13/773,925

(22) Filed: Feb. 22, 2013

(51) Int. Cl. F16L 55/17

(52) U.S. Cl. CPC F16L 55/17
USPC 285/15

(57) ABSTRACT

A mending apparatus or kink mender (100) is utilized to un-kink a soft wall hose section (102), without cutting or splicing the hose. The apparatus (100) is preferably a molded part that encompasses the hose section (102) around the exterior wall (110) by clamping around the outer surface of the hose section (102). This action causes the outside of the hose section (102) to again reform into a true cylinder, which in turn will remove a kink from a kink area (114) and open the interior (104) of the hose (102) so as to allow fluid to again flow through the hose section (102).

### CROSS-REFERENCE TO RELATED APPLICATIONS

Not Applicable.

### STATEMENT REGARDING FEDERALLY SPONSORED RESEARCH OR DEVELOPMENT

Not Applicable.

### PARTIES TO A JOINT RESEARCH AGREEMENT

Not Applicable.

### REFERENCE TO A SEQUENCE LISTING

Not Applicable.

### BACKGROUND OF THE INVENTION

1. Field of the Invention

The invention is related to equipment in the form of hoses or the like for transporting fluids or other non-solid state materials and, more specifically, to apparatus for mending or repairing of kinks in fluidic transport materials such as soft-walled hose, in the form of lawn and garden hose and the like.

2. Background Art

Various types of garden and similar hoses have existed in the prior art for a significant period of time. A number of early hoses used particularly hardened rubber or similar materials for purposes of providing the user with a sturdy and relatively rigid means for achieving fluid flow which could not easily be damaged.

For example, Coleman, U.S. Patent Application Publication Serial No. 2011/0146829, published Jun. 23, 2011, describes a garden hose having an outer covering made of vinyl that is reinforced by cross-knitted fibers. An inner core is secured to and surrounded by the outer covering. The inner core has a generally elongated and cylindrical shape, and includes a backbone that is co-extruded with the inner core. The inner core and the backbone are constructed of polyvinyl chloride (“PVC”). The durometer hardness of the inner core is less than the durometer hardness of the backbone. (A durometer is a device which measures a hardness of a material on any of a number of scales, including a relatively well-known scale identified as the “Shore A Hardness Scale.”)

The backbone extends substantially the entire length of the hose portion, terminating short of the outlet end and the inlet end. The Coleman application publication further describes a method of constructing a hose, and welding extrusion processes for forming the inner core and the backbone. When the inner core is formed, it is introduced into a cooling tank, which causes the PVC to “set.” The fibers associated with the outer covering are then knitted onto the inner core with a knitting machine. The vinyl covering is then extruded onto the hose. If the hose is kinked, the backbone allows for a passageway for water to continue to flow.

Another reference which involves the use of materials associated with the substantially entire length of the hose is Seckel, U.S. Pat. No. 4,867,485 issued Sep. 19, 1989. The Seckel patent discloses a number of general concepts associated with kinking occurring within various types of hose. Specifically, “kinking” occurs when a hose is doubled over or twisted. Seckel explains that kink resistance in hoses which are substantially flexible is related to diameter, wall thickness, and flexibility of the materials from which the hose is constructed Kink resistance is characterized as being inversely proportional to diameter. Regarding effective wall thickness, a “heavier” wall will tend to resist kinking. The flexibility reference or “elongation” (of the material from which the hose is constructed) also has a direct relationship with kink resistance. That is, more flexible materials will tend to bend, rather than kink.

Initially, hoses such as garden hoses and fuel delivery hoses were made with thick walls so as to resist pressure. However, such wall construction made the hoses relatively more cumbersome. As fiber reinforcements became available, weather hoses were wrapped with woven tapes, other coating layers were added, and the entire assembly was often vulcanized. This fiber reinforcement process would allow the total wall thickness to be relatively reduced.

Plastic hoses were subsequently developed, derived from various petrochemicals. Such hoses are typically extruded using soft vinyl thermoplastic. With the advent of plastic hose, the use of tapes was replaced by “knitting” tire cord around the inner core of the hose, followed by the addition of an outer coating. This first process would substantially add to the burst strength and, due to the knitting of the fiber, permit some flexibility of the hose. A more typical approach today is to utilize “wrapped” fiber which is spirally wound around the inner core. Knitted reinforcement allows greater elongation, in view of the inherent ability of the fibers to move and rearrange themselves. In contrast, spiral wound hose consists of straight lines of rigid fiber which restrict elongation, thereby enhancing the tendency of the hose to kink.

Extreme kinking can occur when a new coil of the garden hose is first used. Often, one end is fastened to the faucet and the user walks with the other end away from the faucet without allowing the coiled hose to untwist Kinking will also occur due to the routine movements of the user.

In view of rising prices and the scarcity of petrochemical raw materials, the manufacture of thick walled hose has become relatively uneconomical. Accordingly, hoses are being made with thinner walls, which again results in an increased tendency to kink.

When a thin walled modern hose exhibits a kink, water flow is shut off and the user must attempt to unkink the hose through manual manipulation, such as swinging the hose to relax the kink, or to walk back to the kink and manually straighten the same. Some kinks require the user to walk all the way back to the faucet, shut off the water flow (thereby releasing the pressure), and then unkink the hose. The user is further inconvenienced because of the necessity of walking back to the faucet, turning on the water, and proceeding to the far end to the spray. An even more cumbersome problem arises when the user has already attached a large sprinkler device, such as an oscillating sprinkler, to the end of the hose, and is forced to untwist the hose with this device attached.

To overcome a number of the foregoing problems, Seckel discloses a hose having an outside wall, inside wall, and a series of longitudinally displaced ribs either attached to or extruded as part of the hose. The ribs are continuous along the length of the hose, because when the hoses are made by extrusion, the ribs are formed as part of the inner wall. A primary purpose of the ribs is to prevent the inner walls from touching each other, thereby providing channels for water flow. Both the size of the ribs and their number are considered relatively important. The size of the ribs is restricted by a crimping procedure used to attach a connecting coupler to an end of the hose.

In addition to the radially spaced ribs extending longitudinally between the open ends of the hose, an annular coupling is connected to each of the hose ends so as to facilitate delivery of water under pressure to the hose. Each of the couplings includes an annular corrugation compressed into the hose wall. The corrugation is transverse to the longitudinal ribs so as to provide surface areas of greater and lesser compression for absorbing the ribs into the hose wall, and thereby sealing the hose end against pressurized water leakage. The ribs have a size, number, and hardness all limited to what the hose wall thickness and softness can absorb for sealing against leakage.

However, such relatively sturdy and hardened hoses can be difficult to maneuver without the requirement of machinery or a substantial number of personnel managing the hose. Also, rigidity in hoses makes it extremely difficult to store the hoses in relatively compact containers or the like.

Numerous other prior references disclose various host structures for reducing the tendency of the hoses to kink, while other references disclose various processes for removing kinks from a hose. These references include the following: Dyer, III, U.S. Design Pat. No. D501,539 issued Feb. 1, 2005; Reum, U.S. Pat. No. 5,181,750 issued Jan. 26, 1993; Tressler, U.S. Pat. No. 5,178,421 issued Jan. 12, 1993; Herron et al., U.S. Pat. No. 4,602,808 issued Jul. 29, 1986; and Beal, U.S. Pat. No. 4,411,460.

To overcome problems associated with maneuverability and storage, materials have been developed which provide for “soft” hose materials. These soft hose materials allow greater flexure in their structures. On the other hand, however, various types of hose materials may tend to kink, thereby cutting off or significantly reducing fluid flow through the hose. Repairs of such problems may often lead to damage to the hose itself.

### BRIEF SUMMARY OF THE INVENTION

The invention is directed to means for repairing or mending a kinked hose, without the necessity of cutting or splicing the damaged hose, to reestablish the flow of fluid through the hose. The means includes a molded clamp with a round area, a hinge section, and a wire tie or locking or strap device or optional hook locking (with a lip and clasp) device.

Further in accordance with the invention, a mending apparatus is provided for mending or repairing kinks which result in deformities in a hose. The deformities may be sufficient so as to impede the flow of a fluid through the hose. The mending apparatus includes a clamping means adapted to be received around an outer surface of the hose. Pivot means are connected to the clamping means, for pivoting the clamping means between an open configuration where the clamping means is receivable around the hose at a position of the kink, and a closed position wherein the clamping means are received around the hose at the kink. Coupling means are connected to the clamping means and secure the clamping means around the hose. The clamping means may be secured around the hose in a manner where it is intended for the clamping means to be permanently secured to the hose. Alternatively, the coupling means may be connected to the clamping means in a manner so as to provide for the clamping means to be releasably secured around the hose, with the capability of removing the clamping means when the kink is removed. In accordance with certain aspects of the invention, the clamping means is sized and configured relative to the hose so that when the clamping means is in the closed configuration and received around the hose, the clamping means exerts forces on the hose sufficient to remove the kink and cause the hose to reform into a normal cross-sectional configuration, thereby permitting fluid to again fully flow within the hose. Again, the coupling means may be connected to the clamping means in a manner so that the clamping means is intended for the clamping means to remain secured to the hose. Further, the clamping means may alternatively be configured so as to provide for the clamping means to be released from the hose after the kink is removed.

The clamping means can include a clamp assembly having a first clamp section and second clamp section. Each of the clamp sections can be attached to a pivot means. The first clamp section can include a first clamp section end or edge connected to the pivot means, while the second clamp section can include a second clamp section end or edge also attached to the pivot means. The coupling means is attached in part to a first clamp section opposing end of the first clamp section, and is further attached in part to a second clamp section opposing end of the second clamp section.

The coupling means can include a series of individual locking mechanisms, with each of the locking mechanisms being operable so as to be configured by a user into a locked configuration. The locking mechanism then secures or releasably secures the first clamp section opposing end to a position adjacent to the second clamp section opposing end.

In accordance with other aspects of the invention, the individual locking mechanisms can each include a head mounted on the first clamp section adjacent the first clamp section opposing end. The head can include an aperture and a locking latch. Further, the locking mechanism can include an individual locking strap directly or indirectly coupled to the second clamp section, adjacent the second clamp section opposing end.

When the first and second clamp sections are moved into a closed configuration, the individual locking strap is received within the aperture of the head, and the latch is used to secure or releasably secure the locking strap within the aperture. The individual locking straps can be three in number, and equally spaced along the length of the mending apparatus.

In accordance with other aspects of the invention, the mending apparatus can include a first flexible section attached to the first clamp section opposing end, and a second flexible section attached to a second clamp section opposing end. The first flexible section can be secured or releasably secured to the second flexible section when the clamping means is in the closed configuration received around the hose. The first flexible section can include a lip, and the second flexible section can include a clasp. When the clamping means is in the closed configuration, the lip is securable or releasably securable to the clasp, for purposes of exerting forces by the mending apparatus on the outer surface of the hose.

### BRIEF DESCRIPTION OF THE SEVERAL VIEWS OF THE DRAWING

The invention will be described with respect to the drawings, in which:

FIG. 1 is a plan view of the kink mender in accordance with the invention, and with the clamp assembly being shown in an open position;

FIG. 2 is an end view of the kink mender shown in FIG. 1, again showing the clamp assembly in an open position;

FIG. 3 is a side, elevation view of the kink mender shown in FIG. 1;

FIG. 4 is a left-side front perspective view of the kink mender shown in FIG. 1, and again showing the kink mender with the clamp assembly in an open position;

FIG. 5 is a perspective view of a partial length of a hose, with the hose being in a kinked state and having a kink area therein;

FIG. 6 is a perspective view of the hose shown in FIG. 5, with the kink mender attached to the hose and with the clamp assembly in a closed and locked position around the outer wall of the hose, and with the kink mender causing removal of the kink in the hose as shown in FIG. 5; and

FIG. 7 is a perspective and partial end view of an alternative embodiment of a kink mender in accordance with the invention, and showing the kink mender in a closed and locked position.

### DETAILED DESCRIPTION OF THE INVENTION

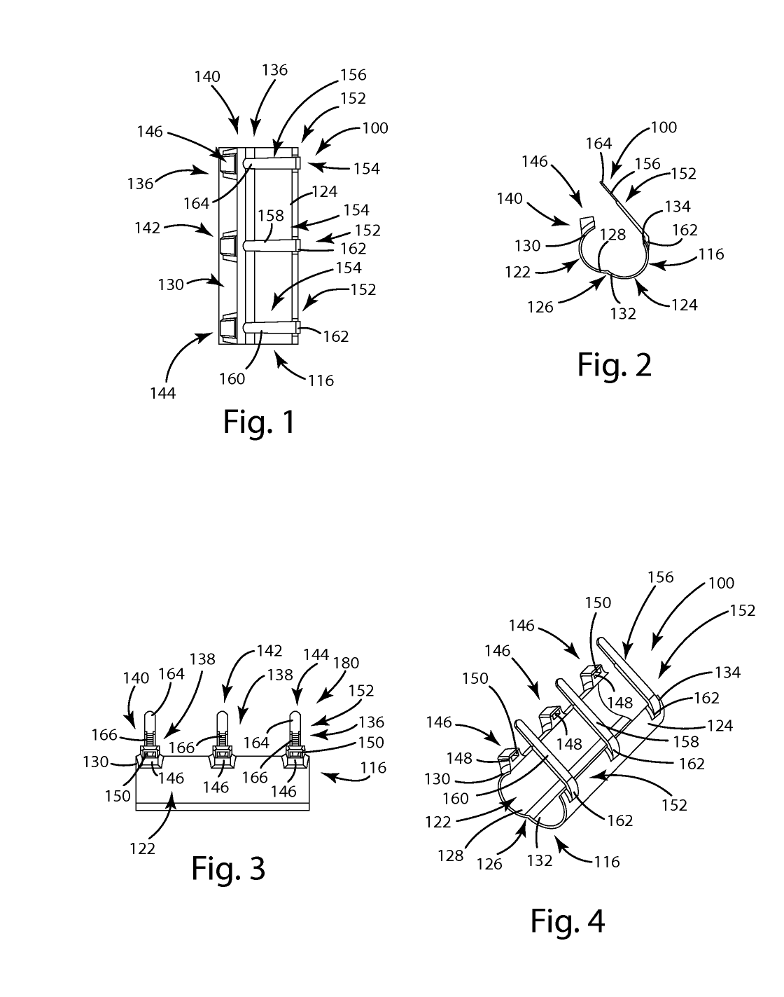

The principles of the invention are disclosed, by way of example, in two embodiments of a mending apparatus or kink mender as illustrated in FIGS. 1-7. A first embodiment of the invention, namely a kink mender or mending apparatus 100, is illustrated in FIGS. 1-4 and 6. An alternative embodiment of a kink mender in accordance with the invention is kink mender or mending apparatus 200 illustrated in FIG. 7. As will be described in subsequent paragraphs herein, kink menders in accordance with the invention provide means for repairing or mending a kinked hose, without any requirement of cutting or splicing a kinked or damaged hose for purposes of reestablishing the flow of fluid through the hose Kink menders in accordance with the invention are operable with various types of hoses, including garden hoses, fuel hoses, and the like. Also, kink members in accordance with the invention are operable with hoses constructed from various types of materials.

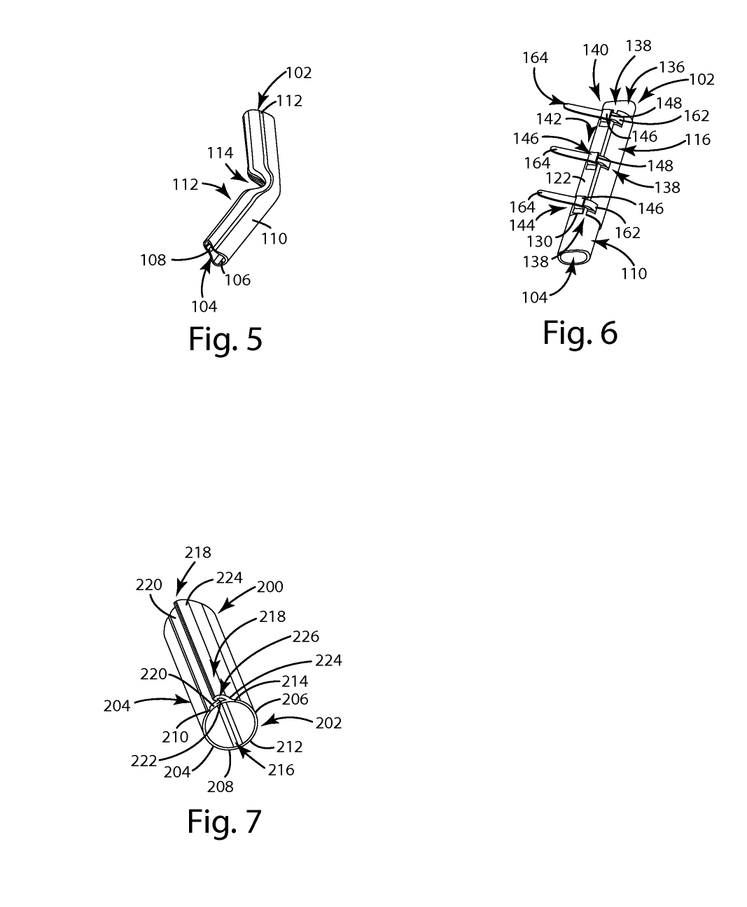

The first embodiment of a kink mender in accordance with the invention, namely kink mender 100, is primarily illustrated in FIGS. 1-4. A partial section of a hose which can be utilized with the kink mender 100 is illustrated as a perspective view in FIG. 5 as hose section 102.

The hose section 102 can be a partial section of a garden hose, fuel hose, or a number of other types of hoses. With reference to FIG. 5, the hose section 102 includes an interior 104 through which fluid may flow. The interior 104 may be constructed of a cylindrical or circular interior wall 106. For purposes of strengthening, the interior wall 106 may be constructed in a well-known manner with a set of interior ribs 108. The outer portion of the hose section 102 includes an exterior wall 110, also having a circular or cylindrical shape, when the hose section 102 is in a “nondeformed” state. As with the interior wall 106, the exterior wall 110 may include a series of spaced apart and longitudinally extending ribs 112. Although the hose section 102 is shown with ribs 108, 112, it should be emphasized that such ribs are not necessary for hoses with which the kink mender 100 or other kink menders in accordance with the invention may be utilized. For purposes of description, the hose section 102 is shown in FIG. 5 as having a kink area 114. The kink area 114, well known by any user of various types of hoses, can cause fluid pressure to increase within the hose section 102, and can also cause a substantial or complete blockage of fluid flow through the hose section 102 at the kink area 114. As previously described in the section entitled “Background Art,” it is often necessary to cut or otherwise splice a kinked hose, so as to remove the obstructive kink. Favorably, kink menders in accordance with the invention negate the need for such cutting or splicing procedures.

Returning to the kink mender 100 as shown in FIGS. 1-4, the kink mender 100 has a substantially annular configuration and extends longitudinally when secured to a hose section 102. The kink mender 100 includes a clamp assembly 116 which extends along the entirety of the length of the kink mender 100. The clamp assembly is particularly shown in FIGS. 2 and 4, and includes a first clamp section 122 having an arcuate configuration and forming substantially a semi-circle. A second clamp section 124 is attached to the first clamp section 122 through a hinge section 126. The second clamp section 124 is also semi-circular in an arcuate configuration, and the hinge section 126 extends along the entirety of the length of the kink mender 100. As shown in FIGS. 1, 2, and 4, the clamp assembly 116 is illustrated in an “open” configuration. When the kink mender 100 is in an appropriate position secured around the hose section 102, the first and second clamp sections 122, 124, respectively, will be moved into a “closed” position. This closed configuration is shown in FIG. 6.

Turning again to FIGS. 1-4, the first clamp section 122 includes a first clamp section end 128 and a first clamp section opposing end 130. The first clamp section end 128 is coupled to the hinge section 126. Correspondingly, the second clamp section 124 has two ends, namely a second clamp section end 132 and a second clamp section opposing end 134. The second clamp section end 132, as with the first clamp section 128, is coupled to the hinge section 126.

Positioned at the first clamp section end 128 of the first clamp section 122 is a locking mechanism set 136. The locking mechanism set 136 is primarily shown in FIGS. 1, 3, and 4, and consists of a plurality of individual locking mechanisms 138. The actual number of individual locking mechanisms 138 can be varied, depending upon the length of the hose section 102, hose weight, size, and other characteristics. Essentially, any number of locking mechanisms 138 can be utilized, without departing from the spirit and scope of the novel concepts of the invention. In the particular embodiment shown FIGS. 1-4, the number of locking mechanisms 138 is three, comprising a first locking mechanism 140, second locking mechanism 142, and third locking mechanism 144. Each of the locking mechanisms 138 is identical to the others of the locking mechanisms 138. In the particular embodiment of the kink mender 100 shown in FIGS. 1-4, each of the locking mechanisms 138 is in the form of a clasp. As shown in perspective view in FIG. 4, the locking mechanism 140 comprises what can be characterized as a “head” extending outwardly from the first clamp section opposing end 130. The head 146 includes an aperture 148 extending entirely through the head 146. Positioned at one end of the opening of the aperture 148 is a latch 150 which is utilized to lock or releasably “lock” a corresponding strap described in subsequent paragraphs herein. That is, each of the locking mechanisms 138 can be configured so as to provide for an intended permanent locking so as to secure the clamp assembly 116 to the hose section 102. Alternatively, the clamp assembly 116 can be configured with an intent to releasably lock corresponding straps into the latches 150 in a manner to provide for releasability, so as to remove the clamp assembly 116 when the kink has been removed from the hose section 102. For purposes of clarity of the drawings, the head 146, aperture 148 and latch 150 are numerically referenced only in FIG. 4, and only with respect to the particular first locking mechanism 140. However, the same components exist with respect to each of the other locking mechanisms 142 and 144. Each of the heads 146 can be manufactured integrally with the clamp assembly 116 or, alternatively, each of the locking mechanisms 138 can be secured to the first clamp section 122 through any suitable connecting means, such as adhesives, rivets or the like.

Turning again to FIGS. 1-4, the kink mender 100 further comprises a wire tie or locking strap set 152. The locking strap set 152 includes a series of three individual wire ties or locking straps 154. For purposes of brevity, the wire ties or locking straps will be referred to herin as “locking straps.” These locking straps are expressly identified as first locking strap 156, second locking strap 158 and third locking strap 160. Each of the locking straps 154 is secured by any suitable connecting means to the second clamp section opposing end 134. Although any number of individual locking straps 154 can be utilized in accordance with the invention (and without departing from the novel concepts of the invention), the number of locking straps 154 should correspond to the number of individual locking mechanisms 138. The number of locking mechanisms 138 and locking straps 154 should be sufficient so as to ensure sufficient strength and “stability” for the kink mender 100 to operate properly in removing kinks from the hoses to which the mender is applied.

With reference to FIGS. 3 and 4, the first locking strap 156 is secured (either integrally or through any suitable connecting means) to the second clamp section opposing end 134 through an arcuate-shaped base 162. One end of a flexible strap section 164 is coupled to the base 162, and the other end of the strap section 164 is spatially free and adapted to be received within aperture 148 of the head 146 of the first locking mechanism 140. As specifically shown in FIG. 3, the flexible strap section 164 includes a series of notches 166. As with a number of commercially available and well known belt and clasp configurations, the notches can be used to lock or releasably lock the strap section 164 to the head 146 by engaging the latch 150. The separate notches 166 provide for the capability of locking or releasably locking the strap section 164 to the locking mechanism 140 at any one of a number of desired positions, dependent upon which of the notches 166 is chosen to engage the latch 150.

The elements of the kink mender 100 relating to the locking strap set 152 have been described with respect primarily to individual locking strap 156. As apparent from the drawings, the first locking strap 156 is associated with and corresponds to the first locking mechanism 140, in that the locking strap 156 will be received within the aperture 148 of the first locking mechanism 140. Although elements of the individual locking strap 154 have been described only with respect to the first locking strap 156, it should be emphasized that the aforedescribed elements of the first locking strap 156 (i.e. the arcuate-shaped based 162, flexible strap section 164 and notches 166) identically exist with respect to the second locking strap 158 and the third locking strap 160.

The operation of the kink mender 100 will now be described with respect not only to FIGS. 1-4, but also with respect to FIGS. 5 and 6. Specifically, FIG. 5, as earlier described, illustrates a hose section 102 having an interior 104, interior wall 106 and interior ribs 108. Also, the hose section 102 consists of an exterior wall 110 and exterior ribs 112. A kink area 114 has formed within the hose section 102, and as apparent from the illustration of FIG. 5, the “normally cylindrical” cross-sectional configuration of the hose section 102 is deformed as a result of the existence of the kink in the kink area 114. The kink area 114 also will clearly substantially reduce or completely prohibit the flow of liquid through the interior 104 of the hose section 102.

To repair or mend the kink in the hose section 102, the kink mender 100 can be positioned and received around the hose section 102 with the clamp assembly 116 in an “open” configuration as shown specifically in FIGS. 2 and 4. When the kink mender 100 is appropriately received around the hose section 102, the first clamp section 122 and the second clamp section 124 can be moved (through the action of pivoting of the hinge section 126) into what can be characterized as a “closed” configuration around the hose section 102. This closed configuration is illustrated in FIG. 6. With the first and section clamp sections 122, 124, respectively, closed around the hose section 102, the individual locking straps or wire ties 154 can then each be engaged with corresponding ones of the individual locking mechanisms 138. That is, the first locking strap 156 can be received within the aperture 148 of the first locking mechanism 140. Correspondingly, the second locking strap 158 can be received within the second locking mechanism 142. Still further, the third locking strap 160 can then be received within the third locking mechanism 144. After the locking straps 154 are received within the locking mechanisms 138, the straps 154 can then be “locked tightly”. The kink mender 100 essentially operates in accordance with the invention by generally applying equal pressures around the circumference of the outer surface of the hose section 102. With sufficient forces applied to the hose section 102, the section 102 will again “reform” into a true cylindrical shape. As the hose section 102 reforms to the cylindrical shape, the kink in the kink area 114 will be removed. Removal of the kink in the kink area 114 will then essentially “open” the interior 104 of the hose section 102. Opening the interior 104 of the hose section 102 will then permit fluid to fully flow through the interior 104, without being impeded by deformities in the kink area 114 and the entirety of the hose section 102 as a result of the kink. When the kink has been completely removed, the kink mender 100 can be either left in place or readily removed from the hose section 102 by undoing the individual locking straps 154 and removing them from the corresponding individual locking mechanisms 138.

As earlier stated, the kink mender 100 in accordance with the invention provides for an advantageous structure to un-kink a hose, such as a soft wall garden hose. The structure provides for the capability of removing the kink from the hose, without any necessity of cutting or splicing the hose. The kink mender 100 can be characterized as an apparatus which is preferably molded, and can be made to encompass the hose on the exterior of the hose by clamping around the outer diameter. This action will cause the outside of the hose to again reform into a true cylindrical configuration. This reformation will, in turn, remove the kink and open the interior of the hose so as to allow fluid to freely flow through the hose.

An alternative embodiment of a kink mender in accordance with the invention is illustrated in FIG. 7 as kink mender 200, and described in subsequent paragraphs herein. With reference to FIG. 7, the alternative kink mender 200 includes a clamp assembly 202, similar to the clamp assembly 116 previously described with respect to the kink mender 100. The clamp assembly 202 includes a first clamp section 204 having a semi-circular cross sectional configuration, and a second clamp section 206, also having a semi-circular cross sectional configuration. Both of the clamp sections 204, 206 extend through the longitudinal length of the kink mender 200. The first clamp section 204 includes a first clamp section end 208 and a first clamp section opposing end 210. Correspondingly, the second clamp section 206 includes a second clamp section end 212 adjacent the first clamp section end 208. The second clamp section 206 also includes a second clamp section opposing end 214. The first clamp section end 208 and the second clamp section end 212 are coupled together through a hinge section 216. The hinge section 216 is utilized to pivot the first and second clamp sections 204, 206, respectively between open configurations and a closed configuration, with FIG. 7 illustrating a closed configuration.

Secured to the first clamp section opposing end 210 and second clamp section opposing end 214 is a latch assembly or hook locking device 218. For purposes of brevity, the latch assembly or hook locking device will be referred to herein as the “latch assembly.” The latch assembly 218 includes a first flexible section 220 which extends along the length of the kink mender 200 and is integral with or otherwise attached through any suitable connecting means to the first clamp section opposing end 210. Correspondingly, integral with or otherwise attached to the first flexible section 220 is a lip 222, which also extends along the length of the kink mender 200. The lip 222 is turned substantially outwardly from the first flexible section 220. Secured to the second clamp section opposing end 214 is a second flexible section 224. As with the first flexible section 220, the second flexible section 224 extends along the entirety of the longitudinal length of the kink mender 200. At the free end of the second flexible section 224 is a clasp or hook 226 which is formed inwardly from the outer circumference of the kink mender 200.

To utilize the alternative kink mender 200, the clamp assembly 202 is positioned in an “open” configuration, with the first clamp section 204 and second clamp section 206 pivoted away from each other through the hinge section 216. The kink mender 200 is then received around the hose to be “unkinked,” and received around the hose at the position of the kink area (the hose is not shown in FIG. 7, but can have the same configuration in the kinked state as shown in FIG. 5). With the mender 200 positioned around the hose, the hinge section 216 can then be operated so as to move the first clamp section 204 and second clamp section 206 together at their opposing ends 210, 212, so as to essentially capture the hose. To tightly secure the kink mender 200 to the hose, the latch assembly 218 can be operated so as to move the first flexible section 220 under the second flexible section 224. With this configuration, the lip 222 can then be captured by the clasp 226. This configuration of the kink mender 200 around the hose will then exert sufficient forces on the hose so as to unkink the hose and restore the hose to a cylindrical configuration.

It will be apparent to those skilled in the pertinent arts that other embodiments of kink menders in accordance with the invention can be designed. That is, the principles of the invention are not limited to the specific embodiments described herein. Accordingly, it will be apparent to those skilled in the art that modifications and other variations of the above-described illustrative embodiments of the invention may be effected without departing from the spirit and scope of the novel concepts of the invention.

What is claimed is:

1. A mending apparatus for mending or repairing kinks which result in deformities in a hose, said deformities being sufficient so as to impede the flow of a fluid through said hose, said mending apparatus comprising:
clamping means adapted to be received around an outer surface of said hose;
pivot means connected to said clamping means, for pivoting said clamping means between an open configuration wherein said clamping means is receivable around said hose at a position of said kink, and a closed position wherein said clamping means is received around said hose at said kink;
coupling means connected to said clamping means for securing or releasably securing said clamping means around said hose; and
said clamping means is sized and configured relative to said hose so that when said clamping means is in said closed configuration and received around said hose, said clamping means exerts forces on said hose sufficient so as to move said kink and cause said hose to reform into a normal cross-sectional configuration, thereby permitting fluid to again fully flow within said hose.

2. A mending apparatus in accordance with claim 1, characterized in that said clamping means comprises a clamp assembly having a first clamp section and a second clamp section, each of said clamp sections being attached to said pivot means.

3. A mending apparatus in accordance with claim 2, characterized in that said first clamp section comprises a first clamp section end or edge connected to said pivot means, and said second clamp section comprises a second clamp section end or edge also attached to said pivot means.

4. A mending apparatus in accordance with claim 2, characterized in that said coupling means is attached in part to a first clamp section opposing end of said first clamp section, and is further attached in part to a second clamp section opposing end of said second clamp section.

5. A mending apparatus in accordance with claim 4, characterized in that said coupling means comprises one or a plurality of locking mechanisms, each of said locking mechanisms being operable so as to be configured by a user into a locked configuration, wherein said locking mechanisms secure or releasably secure said first clamp section opposing end to a position adjacent to said second clamp section opposing end.

6. A mending apparatus in accordance with claim 5, characterized in that each locking mechanism comprises:
a head mounted on said first clamp section adjacent said first clamp section opposing end, said head having an aperture and a locking latch associated therewith; and
an individual locking strap directly or indirectly coupled to said second clamp section adjacent said second clamp section opposing end.

7. A mending apparatus in accordance with claim 6, characterized in that when said first and second clamp sections are moved into a closed configuration, said individual locking strap is then received within said aperture of said head, and said latch is used to secure or releasably secure said locking strap within said aperture.

8. A mending apparatus in accordance with claim 7, characterized in that said individual locking straps are at least one in number, and are spaced apart along the length of said mending apparatus.

9. A mending apparatus in accordance with claim 2, characterized in that coupling means comprises:
a first flexible section attached to said first clamp section opposing end;
a second flexible section attached to said second clamp section opposing end; and
said first flexible section is adapted to be secured or releasably secured to said second flexible section when said clamping means is in said closed configuration and received around said hose.

10. A mending apparatus in accordance with claim 9, characterized in that:
said first flexible section comprises a lip;
said second flexible section comprises a clasp; and
when said clamping means is in said closed configuration, said lip is securable or releasably securable to said clasp, for purposes of exerting forces by said mending apparatus on an outer surface of said hose.
